(19) United States
(12) Patent Application Publication
(10) Pub. No.: US 2007/0147533 A1
(43) Pub. Date: Jun. 28, 2007

(54) Method and system for aggregate channel estimation for frequency-selective transmit beamforming

(75) Inventors: Timothy A. Thomas, Palatine, IL (US); Frederick W. Vook, Schaumburg, IL (US); Xiangyang Zhuang, Hoffman Estates, IL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/317,382

(22) Filed: Dec. 23, 2005

(51) Int. Cl. H04L 1/02

(52) U.S. Cl. 375/267

(57) ABSTRACT

A system (10) and method (50) of operating a wireless communication system between a transmit device (12) employing an array of transmit antennas and a receiver (15) can include transmitting (52) a beamformed signal with antenna weights computed based on knowledge of a plurality of channels forming an aggregate channel and computing (54) a set of characteristics for the aggregate channel such as a power delay profile, a frequency correlation, or an expected beamforming gain of the aggregate channel. Characteristics can also be based on factors among a number of transmit antennas, a beamforming weight application delay value, an expected Doppler profile, or an expected delay profile of the propagation channel. The method can further determine (58) a channel estimator based on the computed set of characteristics, receive (62) the beamformed signal, and compute (64) an aggregate channel estimate as a function of the channel estimator and the beamformed signal.

### FIELD OF THE INVENTION

This invention relates generally to communication systems, and more particularly to a method and system for aggregate channel estimation from signals received from a transmit antenna array.

### BACKGROUND OF THE INVENTION

Frequency-selective transmit beamforming of data streams affects an aggregate channel seen by a receiver and, if not estimated properly, a significant portion of the gain will be lost. Existing frequency-domain or time-domain channel estimators are inadequate because their assumed channel correlation models are invalid after the transmit weights are applied to each subcarrier.

### SUMMARY OF THE INVENTION

Embodiments in accordance with the present invention can provide a channel estimator such as a minimum mean-square error (MMSE)-based channel estimator for transmit beamformed aggregate channels based on the proper modeling of the aggregate channel. The aggregate channel depends on the applied transmit weights at each subcarrier. More precisely, it can be a composite channel which, in the frequency domain, is the inner product of transmit weight vector and the channel vector at each subcarrier. In the time domain, this aggregate channel can be the circular convolution, summed over all transmit antennas, of the temporal responses of the multi-path channels with the temporal responses of transmit weights (i.e., IFFT of the transmit weights at all subcarriers for each antenna). Thus, the receiver no longer sees an ordinary channel that is limited in time to a small delay spread, but potentially sees an aggregate channel as long as the FFT size. The channel seen at the receiver can depend on the transmit weights that can and often will be correlated with the channel. In fact, in a typical closed-loop beamforming process, the weights are derived from the channel at one time and then applied after some delay. To best estimate the channel at the receiver, an appropriate correlation model of the aggregate channel can be computed for an estimator such as an MMSE-based channel estimator that exploits the statistical correlation of the channel. In addition to the interaction between the transmit weights and the channel, the modeling can also account for the latencies inherent in the closed-loop beamforming process, namely the delay between the instance when the downlink channel is estimated for the purposes of calculating the transmit beamforming weights (where the downlink channel is measured either by the subscriber or by the base in a time division duplex (TDD) reciprocity-based methodology) and when transmit beamforming actually takes place on the downlink. Embodiments herein can include an MMSE-based channel estimator for transmit beamformed aggregate channels that uses this proper modeling of the aggregate channel.

In a first embodiment of the present invention, a method of operating a wireless communication system between a transmit device employing an array of transmit antennas and a receiver where the transmit device transmits a beamformed signal with antenna weights computed based on knowledge of a plurality of channels forming an aggregate channel can include the receiver steps of computing a set of statistical characteristics of the aggregate channel that represents a composite effect of transmit beamforming and an actual propagation channel, and determining a channel estimator based on the computed set of statistical characteristics. The method further includes the steps of receiving the beamformed signal and computing an aggregate channel estimate as a function of the channel estimator and the beamformed signal.

Computing the set of statistical characteristics can include computing at least one characteristics among a power delay profile of the aggregate channel, a frequency correlation of the aggregate channel, or an expected beamforming gain of the aggregate channel. The step of computing the set of statistical characteristics can further include computing the characteristics based on at least one of the factors among a number of transmit antennas, a beamforming weight application delay value, an expected Doppler profile, or an expected delay profile of the propagation channel. The factor of the expected delay profile can include for example a rectangular profile based on the expected maximum delay spread or an exponential profile based on the expected root mean square (RMS) delay spread. The expected Doppler profile can include a Doppler profile determined from a speed value. Determining the channel estimator can involve determining an MMSE channel estimator to estimate a frequency response of the aggregate channel or alternatively determining a channel estimator to estimate the equivalent temporal response of the aggregate channel. Determining the channel estimator can be performed using a particular transmit beamforming strategy selected among pre-equalization, eigenbeamforming, maximal ratio beamforming, or transmit space division multiple access (SDMA). Computing the aggregate channel estimate can also involve computing an aggregate channel estimate for multiple frequency-domain sub-carriers.

In a second embodiment of the present invention, a receiver unit in communication with a transmit device having an array of transmit antennas can include a receiver and a processor coupled to the receiver. The receiver unit can be programmed to receive a beamformed signal and compute a set of characteristics for an aggregate channel that represents a composite effect of transmit beamforming and an actual propagation channel. The receiver can be further programmed to determine a channel estimator based on the computed set of statistical characteristics and compute an aggregate channel estimate as a function of the channel estimator and the beamformed signal. From another perspective, the receiver unit can compute the set of characteristics from the beamformed signal using a plurality of frequency selective weights and a frequency-selective multi-antenna channel response to create an aggregate channel estimate. The receiver unit can be further programmed to demodulate and decode a received beamformed signal using the aggregate channel estimate.

The processor can be further programmed to provide the array of transmit antennas with a channel estimate at a first time value and transmit by the array of transmit antennas a multi-antenna signal at a second time interval based on the channel estimate at the first time interval. The receiver unit can provide the channel estimate to the array of transmit antennas by transmitting a sounding waveform or a feedback message from the receiver unit to the transmit device. The aggregate channel estimate can be computed based on information selected among a time difference between the second time value and the first time value or a frequency correlation function computed based on an aggregate channel delay spread profile (which may be based on the time difference between the second time value and the first time value). The processor can also model the aggregate channel using a particular transmit beamforming strategy selected among maximal ratio beamforming or transmit space division multiple access (SDMA) in a minimum mean-square error (MMSE)-based channel estimator. More particularly, the receiver unit can model the aggregate channel by applying transmit weight vectors to each subcarrier in the aggregate channel by forming a product of transmit weight vectors and channel vectors at each subcarrier in the frequency domain or by the circular convolution of a multipath channel with an IFFT across frequency of the transmit weight vectors.

In a third embodiment of the present invention, a system including a transmit antenna array employing frequency selective closed-loop beamforming for estimating an aggregate channel can include a receiver unit having a receiver in communication with the transmit antenna array, and a processor coupled to the receiver. The receiver unit can be programmed to receive a beamformed signal from the transmit antenna array and compute a set of characteristics for an aggregate channel that represents a composite effect of transmit beamforming and an actual propagation channel. The receiver can be further programmed to determine a channel estimator based on the computed set of statistical characteristics and compute an aggregate channel estimate as a function of the channel estimator and the beamformed signal. From another perspective, the receiver unit can compute the set of characteristics from the beamformed signal using a plurality of frequency selective weights and a frequency-selective multi-antenna channel response to create an aggregate channel estimate. The receiver can be further programmed to demodulate and decode a received beamformed signal using the aggregate channel estimate.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is power delay profile of the channel between any one of the transmit antennas and the receiver in an existing transmit adaptive antenna array system.

FIG. 2 is a power delay profile of an aggregate channel in accordance with an embodiment of the present invention when the transmit antenna weights at each subcarrier are perfectly matched to the channels at respective subcarriers.

FIG. 3 is a frequency correlation of the aggregate channel when the transmit antenna weights are perfectly matched to the channels in accordance with an embodiment of the present invention.

FIG. 4 is a block diagram of a system for estimating an aggregate channel in accordance with an embodiment of the present invention.

FIG. 5 is a flow chart illustrating a method of estimating an aggregate channel in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein involve methods and systems for the estimation of the aggregate frequency-domain channel when transmit beamforming is applied, where the aggregate channel means the combination of the baseband propagation channel and frequency-selective transmit beamforming weights. In one embodiment, the power delay profile of the aggregate channel at the receiver after the transmitter applies transmit adaptive array (TxAA) weights is derived first. Next, using the power delay profile, the resulting frequency-domain correlation (in both time and frequency) is derived. Finally, the frequency-domain correlation is used to design a MMSE-based channel estimator for the aggregate channel.

The power delay profile and the frequency-domain correlation of the aggregate channel after applying TxAA weights, which provides further insight into the embodiments herein, will be derived. In the derivation, a continuous-time representation of the aggregate channel will be adopted. Typically, the channel is represented as a summation of a discrete number of delta functions corresponding to the incoming paths, but it is more convenient to use a continuous time function to represent the channel response in the following power delay profile analysis because a discrete ray can arrive at any time statistically.

Using the continuous time channel representation with the time lag denoted by variable x, assume the channel response between M base station

antennas and a single antenna subscriber at one particular time instance, denoted with variable t, as

$${h}_{t} ( x ) = [ \begin{matrix}{h}_{t , 1} ( x ) \\ ⋮ \\ {h}_{t , M} ( x )\end{matrix} ] \qquad ( 1 )$$

Also denote the time-domain vector of weight filters applied on the transmit antennas as

$$w ( x ) = [ \begin{matrix}{w}_{1} ( x ) \\ ⋮ \\ {w}_{M} ( x )\end{matrix} ] \qquad ( 2 )$$

Note that the antenna weights are applied in the frequency domain on each subcarrier in an OFDM system (i.e., the FFT of wₘ(x) is applied on each subcarrier from transmit antenna m). Since the antenna weights can, in theory, be independent from subcarrier to subcarrier, the equivalent time domain filter (i.e., wₘ(x)) of the frequency domain weights on each antenna can be any function.

With the weight defined in (2), the aggregate channel at time lag z is then

$$g ( z ) = {\sum }_{m = 1}^{M} \int {h}_{t , m} ( x ) {w}_{m} ( z - x ) ⅆ x = {\sum }_{m = 1}^{M} {g}_{m} ( z ) \qquad ( 3 )$$

With respect to the power delay profile and frequency domain correlation of the aggregate channel, the power delay profile of the aggregate channel g(z) is

$$\begin{matrix}E \{ {\vert g ( z ) \vert}^{2} \} = E \{ {\sum }_{{m}_{1}} {g}_{m} ( z ) {\sum }_{{m}_{2}} {g}_{{m}_{2}}^{*} ( z ) \} \\ = E \{ {\sum }_{{m}_{1}} {\sum }_{{m}_{2}} {g}_{{m}_{1}} ( z ) {g}_{{m}_{2}}^{*} ( z ) \} \\ = E \{ {\sum }_{{m}_{1} = {m}_{2} = m} {\vert {g}_{m} ( z ) \vert}^{2} + {\sum }_{{m}_{1} \neq {m}_{2}} {g}_{{m}_{1}} ( z ) {g}_{{m}_{2}}^{*} ( z ) \}\end{matrix} \qquad ( 4 )$$

where E{} is the ensemble average over all possible realization of channels. Those terms in (4) with m₁=m₂=m can be written as

$$\begin{matrix}E \{ {\sum }_{{m}_{1} = {m}_{2} = m} {\vert {g}_{m} ( z ) \vert}^{2} \} = {\sum }_{m} E {\vert {g}_{m} ( z ) \vert}^{2} \\ = \begin{matrix}{\sum }_{m} E \\ \{ \int {h}_{t , m} ( x ) {w}_{m} ( z - x ) ⅆ x \int {h}_{t , m}^{*} ( y ) {w}_{m}^{*} ( z - y ) ⅆ y \}\end{matrix}\end{matrix} \qquad ( 5 )$$

Further assume that the weight filter wₘ(x) is matched to the true channel but is outdated (by a weights application delay value, d) (not to be confused with power delay or channel delay), i.e., wₘ(x)=h*_{t-d,m} (−x), then

$$\begin{matrix}E {\vert {g}_{m} ( z ) \vert}^{2} = E \{ \int \int {h}_{t , m} ( x ) {h}_{t - d , m}^{*} ( z + x ) {h}_{t , m}^{*} ( y ) {h}_{t - d , m} ( z + y ) ⅆ x ⅆ y \} \\ = \int \int E \{ {h}_{t , m} ( x ) {h}_{t - d , m}^{*} ( z + x ) {h}_{t , m}^{*} ( y ) {h}_{t - d , m} ( z + y ) \} ⅆ x ⅆ y\end{matrix} \qquad ( 6 )$$

Assuming the channel responses at different delays are independent because the gains of multipath components arriving at different time lags are uncorrelated, i.e., h_{t,m}(x) and h_{t,m}(x+ε) are independent if ε≠0, the above integral will be evaluated for the two cases of z≠0 and z=0 separately in the following. For the first case of z=0,

$$\begin{matrix}E {\vert {g}_{m} ( 0 ) \vert}^{2} = \int \int E \{ {h}_{t , m} ( x ) {h}_{t - d , m}^{*} ( x ) \} E \{ {h}_{t , m}^{*} ( y ) {h}_{t - d , m} ( y ) \} ⅆ x ⅆ y \\ = \int \int {P}_{h , m} ( x ) {J}_{0} ( 2 π {f}_{max} d ) {P}_{h , m} ( y ) {J}_{0} ( 2 π {f}_{max} d ) ⅆ x ⅆ y \\ = {J}_{0}^{2} ( 2 π {f}_{max} d ) \int \int {P}_{h , m} ( x ) {P}_{h , m} ( y ) ⅆ x ⅆ y \\ = {J}_{0}^{2} ( 2 π {f}_{max} d )\end{matrix} \qquad ( 7 )$$

where P_{h,m}(.) is the power delay profile of the m-th antenna channel (the profile is typically the same for all antennas) and J₀(.) is the zero-order Bessel function of the first kind. In the derivation above, a Jakes power Doppler profile with a maximum Doppler frequency of fₘₐₓ is assumed at each channel delay (note that the Jakes power Doppler profile can be replaced with another function if another power Doppler profile is used).

For the second case of z≠0, the double integral in (6) degenerates to a single integral because the independence between the channel responses at any two different delays makes the non-zero values only appear at x=y, i.e.,
E|gₘ(z≠0)|²=∫E{h_{t,m}(x)|²}E{h_{t-d,m}(z+x)|²}dx=∫P_{h,m}(x)P_{h,m}(z+x)dx (8)

After examining the terms in (4) with m₁=m₂=m, those cross terms in (4) can be written as

$$\begin{matrix}E \{ {g}_{{m}_{1}} ( z ) {g}_{{m}_{2}}^{*} ( z ) \} = E \{ \int \int {h}_{t , {m}_{1}} ( x ) {h}_{t - d , {m}_{1}}^{*} ( z + x ) \\ {h}_{ t , {m}_{ 2}}^{*} ( y ) {h}_{ t - d , {m}_{ 2}} ( z + y ) ⅆ x ⅆ y \} \\ = \int \int E \{ {h}_{t , {m}_{1}} ( x ) {h}_{t - d , {m}_{1}}^{*} ( z + x ) \\ {h}_{ t , {m}_{ 2}}^{*} ( y ) {h}_{ t - d , {m}_{ 2}} ( z + y ) \} ⅆ x ⅆ y\end{matrix} \qquad ( 9 )$$

Again, two cases of z will be addressed separately. For z=0, equation (9) Gives

$$\begin{matrix}E \{ {g}_{{m}_{1}} ( 0 ) {g}_{{m}_{2}}^{*} ( 0 ) \} = \int \int E \{ {h}_{t , {m}_{1}} ( x ) {h}_{t - d , {m}_{1}}^{*} ( x ) \} \\ E \{ {h}_{t , {m}_{2}}^{*} ( y ) {h}_{t - d , {m}_{2}} ( y ) \} ⅆ x ⅆ y \\ = \int \int {P}_{h , {m}_{1}} ( x ) {J}_{0} ( 2 π {f}_{max} d ) {P}_{h , {m}_{2}} ( y ) \\ {J}_{0} ( 2 π {f}_{max} d ) ⅆ x ⅆ y \\ = {J}_{0}^{2} ( 2 π {f}_{max} d )\end{matrix} \qquad ( 10 )$$

For z≠0, the double integral in (9) is degenerated to a single integral because the independence between the channel responses at any two different delays makes the non-zero values only appear at x=y, i.e.,

$$\begin{matrix}E \{ {g}_{{m}_{1}} ( z ) {g}_{{m}_{2}}^{*} ( z ) \} = \int E \{ {h}_{t , {m}_{1}} ( x ) {h}_{t , {m}_{2}}^{*} ( x ) \} \\ E \{ {h}_{t - d , {m}_{1}}^{*} ( z + x ) {h}_{t - d {,}_{{m}_{2}}} ( z + x ) \} ⅆ x \\ = {J}_{0}^{2} ( \frac{2 π \vert {m}_{1} - {m}_{2} \vert {Δ}_{a}}{λ} ) \int {P}_{h , {m}_{1}} ( x ) {P}_{h , {m}_{2}} ( z + x ) ⅆ x\end{matrix} \qquad ( 11 )$$

where λ is the wavelength and Δₐ is the antenna spacing in wavelengths (assuming a uniform linear array, although the expression in (11) can be easily modified to other array geometries such as a uniform circular array). The above derivation used the fact that the correlation function of the channels corresponding to antennas is a zero-order Bessel function of the first kind when the rays are omni-directional with uniform distribution in [0,2π]. With all the assumptions made before, and counting all the terms in equation (4), the final power profile of the aggregate channel can be written as

$$E \{ {\vert g ( z ) \vert}^{2} \} = \{ \begin{matrix}{M}^{2} {J}_{0}^{2} ( 2 π {f}_{max} d ) , & z = 0 \\ C \int {P}_{h} ( x ) {P}_{h} ( z + x ) ⅆ x , and & z \neq 0 \\ C ≡ M + 2 {\sum }_{q = 1}^{M - 1} ( M - q ) {J}_{0}^{2} ( \frac{2 π q {Δ}_{a}}{λ} ) & \end{matrix} \qquad ( 12 )$$

Two commonly used channel profile functions Pₕ(.) (i.e., rectangular and exponential) are analyzed in the following.

With respect to the Rectangular Profile, this simplest delay profile can be expressed as

$${P}_{h} ( x ) = \{ \begin{matrix}\frac{1}{{τ}_{max}} , & 0 \leq x \leq {τ}_{max} \\ 0 , & otherwise\end{matrix} \qquad ( 13 )$$

Inserting (13) into (12) yields

$$E {\vert g ( z ) \vert}^{2} = \{ \begin{matrix}C \frac{{τ}_{max} + z}{{τ}_{max}^{2}} , & - {τ}_{max} \leq z < 0 \\ {M}^{2} {J}_{0}^{2} ( 2 π {f}_{max} d ) , & z = 0 \\ C \frac{ {τ}_{max} - z}{{τ}_{max}^{2}} , & 0 < z \leq {τ}_{max} \\ 0 , & elsewhere\end{matrix} = C \frac{{τ}_{max} - \vert z \vert}{{τ}_{max}^{2}} + [ {M}^{2} {J}_{0}^{2} ( 2 π {f}_{max} d ) - \frac{C}{{τ}_{max}} ] δ ( z ) , \vert z \vert \leq {τ}_{max} \qquad ( 14 )$$

The frequency domain correlation can be obtained from the power delay profile by

$$\begin{matrix}R [ k ] = \int E {\vert g ( z ) \vert}^{2} {ⅇ}^{- j2π k Δ fz} ⅆ z \\ = {M}^{2} {J}_{0}^{2} ( 2 π {f}_{max} d ) - \frac{C}{{T}_{max}} + C \frac{2 - 2 cos ( 2 π k Δ f {τ}_{max} )}{{( 2 π k Δ f {τ}_{max} )}^{2}}\end{matrix} \qquad ( 15 )$$

where Δf is the subcarrier spacing, Tₘₐₓ is the number of samples contained in 0 to τₘₐₓ, (τₘₐₓ is the maximum expected delay spread), and k is the difference between two subcarrier indices.

Another widely used delay profile is the exponential profile, which is expressed as

$${P}_{h} ( x ) = \{ \begin{matrix}\frac{1}{{τ}_{RMS}} exp ( - \frac{x}{{τ}_{RMS}} ) , & x \geq 0 \\ 0 , & otherwise\end{matrix} \qquad ( 16 )$$

Where τ_{RMS} is the expected root mean square (RMS) delay spread. The exponential profile gives

$$E {\vert g ( z ) \vert}^{2} = \{ \begin{matrix}{M}^{2} {J}_{0}^{2} ( 2 π {f}_{max} d ) , & z = 0 \\ \frac{C}{2 {τ}_{RMS}} exp ( - \frac{\vert z \vert}{{τ}_{RMS}} ) , & z \neq 0\end{matrix} = \frac{C}{2 {τ}_{RMS}} exp ( - \frac{\vert z \vert}{{τ}_{RMS}} ) + [ {M}^{2} {J}_{0}^{2} ( 2 π {f}_{max} d ) - \frac{C}{2 {τ}_{RMS}} ] δ ( z ) \qquad ( 17 )$$

The frequency domain correlation can be obtained from the power delay profile by

$$\begin{matrix}R [ k ] = \int E {\vert g ( z ) \vert}^{2} {ⅇ}^{- j2π k Δ fz} ⅆ z \\ = {M}^{2} {J}_{0}^{2} ( 2 π {f}_{max} d ) - \frac{C}{2 {τ}_{RMS}} + \frac{C}{1 + {( 2 π k Δ f {τ}_{max} )}^{2}}\end{matrix} \qquad ( 18 )$$

where Δf is the subcarrier spacing and k is the difference between two subcarrier indices.

It should be noted that frequency correlations that are simplified versions of either (15) or (18) can be used. For example, a simplified version of (15) could be the following where the transmit antennas are assumed to be uncorrelated:

$$R [ k ] = \{ \begin{matrix}{MJ}_{0}^{2} ( 2 π {f}_{max} d ) + \frac{1}{{( 2 π k Δ f {τ}_{max} )}^{2}} ( 2 - 2 cos ( 2 π k Δ f {τ}_{max} 0 ) ) & if k \neq 0 \\ 1 + {MJ}_{0}^{2} ( 2 π {f}_{max} d ) & if k = 0\end{matrix}$$

Comparing theoretically derived power delay profiles and frequency domain correlation with Monte Carlo simulations can further provide further insight to the effectiveness of the embodiments herein. The simulated channel model can be a COST259 channel model (as known in the art) with a single cluster (RMS delay spread is 0.5 μs) with an angular spread of 15°. The power delay profile can be exponential, but the power angular spread is Laplacian and the angle distribution is Gaussian, which is different from the uniform distribution assumed in the derivation above.

Eight antennas (M=8) with half-wavelength spacing (i.e., Δₐ=λ/2) are used at the base and a single antenna is assumed at the mobile. The antenna weights are applied at each OFDM subcarrier where the OFDM system has 1024 subcarriers with 768 of them bearing data. The sampling rate is 25.6 MHz and CP length is 256, which give a subcarrier spacing of Δf=25 kHz.

In the simulation, the rays with arbitrary times of arrival are statistically generated according to the COST259 model. The antenna vector channel at the sampling rate is generated by convolving the rays with the analog filter that models all the analog filtering effect in the transmitter and receiver (including D/A and A/D filters), and then by sampling at 25.6 MHz. A raised cosine filter is used to model the analog filter chains. A roll-off factor of 0.22 is also used (which will not cause any distortion to any of the data-carrying subcarriers of the OFDM system).

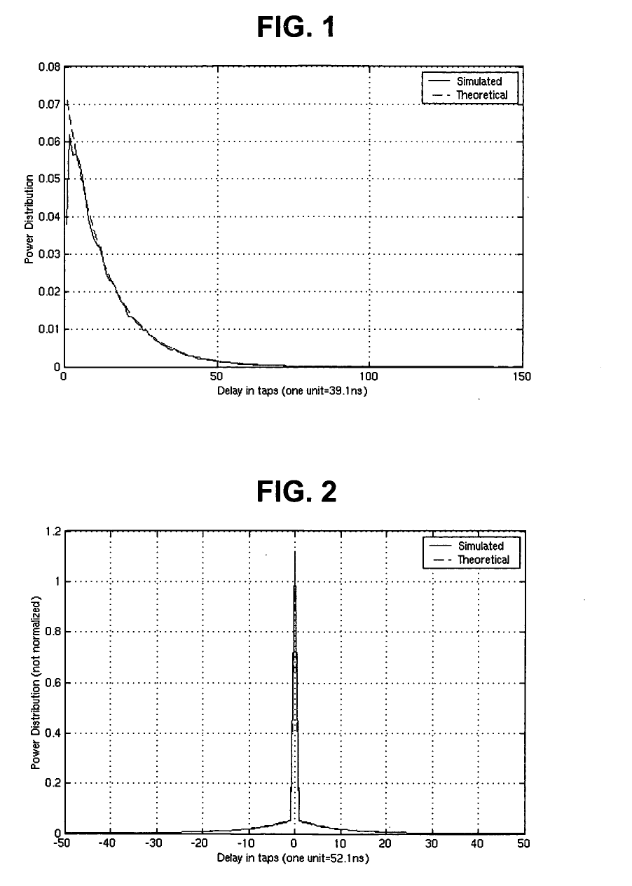

First, the power delay profile computed from the sampled channel response is plotted in FIG. 1. Note that the 0.5 μs delay spread translates into 0.5 μs*25.6 MHz=12.8 taps in the figure. As expected, the power delay profile of the simulated channel matched the theoretical curve of equation (16) very well, except for a few starting taps. These taps are due to the precursor taps of the analog pulse shaping filter that is approximated by a raised cosine function in the simulation.

Next, the case of single transmit antenna is investigated where the transmit weight perfectly matches the channel at each subcarrier (i.e., the transmit weight at each lag x wₘ(x) is just wₘ(x)=h*_{t-d,m}(x) with d=0). Note that a single transmit antenna is shown for simplicity, but the aggregate channel characteristics with more than one transmit antenna is similar. Also note that the weight is just a scalar here for this single antenna case and the weight at each subcarrier is not normalized to unit magnitude, which makes wₘ(x) exactly equal to h*_{t,m}(x). With such a weight, the power delay profile of the aggregate channel is plotted in FIG. 2. The weight is applied in the frequency domain, but the time-domain aggregate channel is obtained by taking a 768-point IFFT of the frequency domain aggregate channel (hence, the sampling interval is changed from 1/25.6 MHz=39.1 ns in FIG. 1 to 52.1 ns here in FIG. 2. This power profile matches the theoretical curve very well (equation (17) with M=1, d=0, and C=1). The power delay profile shown in FIG. 2 shows another important aspect of the embodiments herein which is that the mobile's channel estimator needs good synchronization to take advantage of the power delay profile. This is because the spike in the power delay profile is at one specific time lag value (e.g., at lag 0) and thus synchronization error could make it appear that the spike is at a different lag. Fortunately the mobile can easily correct for the synchronization error by estimating the lag of the spike in a beamformed transmission (e.g., by using frequency estimation methods known in the art such as ESPRIT or FFT-based methods for determining dominant frequencies where the dominant frequency will correspond to the lag value of the spike in the presence of synchronization error).

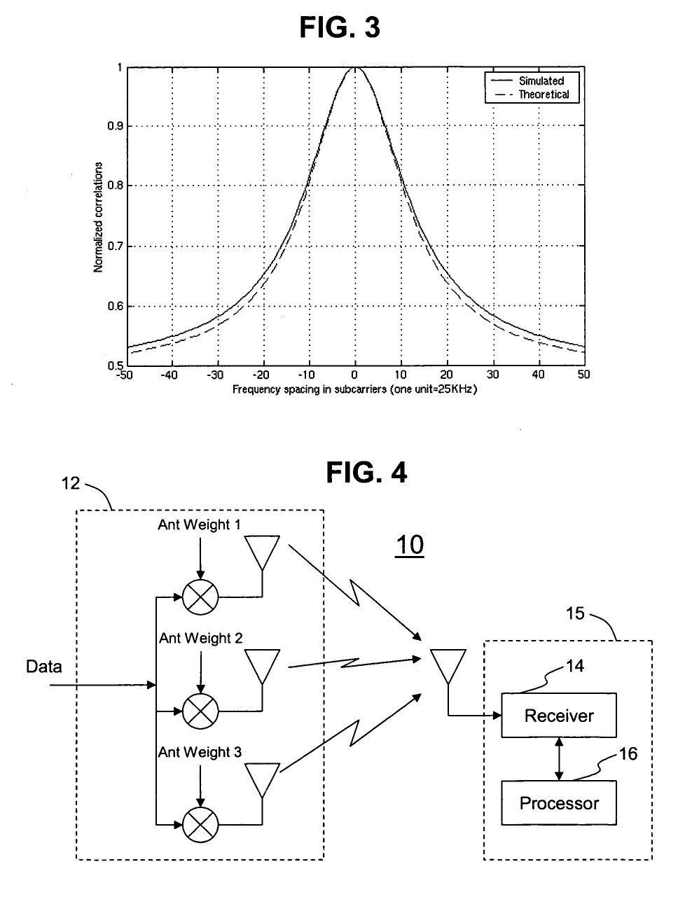

The normalized frequency domain correlation of the aggregate channel is plotted in FIG. 3, which also matches the theoretical prediction (equation (18) after normalization) very well.

Comparing various Single-Stream TxAA Methods with Aggregate Channel Estimation at the Mobile provides yet further insight to the various embodiments. This section contains a summary of TxAA methods such as pre-equalization TxAA, per-subcarrier TxAA, and fixed-weight TxAA (i.e., eigenbeamforming as known in the art) for an OFDM downlink. The comparison includes channel estimation of the aggregate TxAA channel using the proper frequency-domain correlation which was given before. A brief overview of each TxAA method is now given. The pre-equalization TxAA weight on subcarrier k is given as (where the equalization is done over K subcarriers):

$$v ( k ) = α \frac{H * ( k )}{{H}^{H} ( k ) H ( k )} \qquad ( 19 )$$

where H(k) is the estimate of the downlink channel on subcarrier k and α is a scaling to normalize v(k) and is given by:

$$α = \frac{1}{\sqrt{\frac{1}{K} {\sum }_{k = 1}^{K} {v}^{H} ( k ) v ( k )}} \qquad ( 20 )$$

The per-subcarrier TxAA weights (also known as maximal ratio transmission weights) are given as:

$$v ( k ) = \frac{H * ( k )}{\sqrt{{H}^{H} ( k ) H ( k )}} \qquad ( 21 )$$

Note that the per-subcarrier TxAA weights are normalized to unit power on each subcarrier. The fixed TxAA weight (also known as eigenbeamforming weight in the art) is given as the unit-power eigenvector associated with the largest eigenvalue of R where R is given as:

$$R = {\sum }_{k = 1}^{K} H ( k ) {H}^{H} ( k ) \qquad ( 22 )$$

One embodiment uses the per-subcarrier transmit weights (21) and the channel estimation strategy for TxAA is the following 2-D MMSE channel estimator. Despite only the details for a 2-D MMSE channel estimator being given below, other channel estimators can also take advantage of the modeling of the aggregate channel previously derived. For example 1-D MMSE channel estimators can be designed using the expected frequency correlation of the aggregate channel. Another example is time-domain tap estimators (e.g., IFFT estimators as known in the art) that use the expected delay profile of the aggregate channel to weight taps that have less mean power statistically with a value smaller than taps having more mean power. Note that the common aspect of all of the mentioned channel estimation techniques is that they are determined/operate based on the number of transmit antennas, the TXAA application delay value, the expected Doppler profile, and the expected delay profile. In other words, the number of transmit antennas, the channel excess delay value, the expected Doppler profile, and the expected delay profile help determine what the expected power delay profile of the aggregate channel will be and it is the expected power delay profile of the aggregate channel which determines the channel estimator.

The 2-D MMSE channel estimate for receive antenna m at subcarrier k and baud b is given as:

$${\hat{H}}_{m} ( k , b ) = {\sum }_{p = 1}^{P} {V}_{p} ( k , b ) {\tilde{H}}_{m} ( {k}_{p} , {b}_{p} ) \qquad ( 23 )$$

where P is the number of pilot symbols on a resource element (RE) which contains a number of consecutive subcarriers and a number of OFDM symbols, (k₁,b₁) through (k_{P},b_{P}) are the pilot locations (subcarrier number and baud number) on the RE, and Vₚ(k,b) is the frequency- and time-dependent MMSE weighting on the noisy channel estimate. The noisy channel estimate is given as:
\tilde{H}(kₚ,bₚ)=Yₘ(kₚ,bₚ)x*(kₚ,bₚ) (24)
where x(kₚ,bₚ) for p=1, . . . , P are the pilot symbols which are assumed to be constant modulus symbols (if non constant modulus symbols are used, then the multiplication by the conjugate of the pilot symbols is replaced by a division by the pilot symbols).

Before giving the equation for the MMSE weighting, Vₚ(k,b), some important notes about the MMSE weighting are:
1. A different weighting is needed for each RE type of different dimension.
2. A different weighting is needed on each subcarrier and baud.
3. The MMSE weighting can be pre-computed and stored instead of being computed in real time. However, besides saving memory storage, computing in real time allows the channel estimator to adapt to instantaneous channel conditions.
4. The MMSE weighting is dependent on speed, noise, TxAA sounding delay (i.e., the weights application delay value, d), and delay spread so multiple MMSE weightings must be stored if the MMSE weighing is not computed in real time. In either case, noise plus velocity (and possibly delay spread) measurements are needed at the mobile.
5. To update the weightings in real time, a single P×P real matrix needs to be inverted.
   Note that another way to describe item four in the above list is determining a channel estimator based on the number of transmit antennas, the weights application delay value, the expected Doppler profile, and the expected delay profile

The MMSE weightings for the channel estimate on subcarrier k and baud b for all P pilot symbols are given as:

$$V ( k , b ) = [ \begin{matrix}{V}_{1} ( k , b ) \\ ⋮ \\ {V}_{P} ( k , b )\end{matrix} ] = {( {R}_{p} + \frac{{σ}_{n}^{2}}{G} {I}_{P} )}^{- 1} g ( k , b ) \qquad ( 25 )$$

where σₙ² is the noise power, G is the expected gain of TxAA (see below), I_{P} is a P×P identity matrix, and P×P Rₚ and P×1 g(k,b) are given as:

$$\begin{matrix}{R}_{p} = [ \begin{matrix}{R}_{f} ( 0 ) {R}_{t} ( 0 ) & {R}_{f} ( {k}_{2} - {k}_{1} ) {R}_{t} ( {b}_{2} - {b}_{1} ) & ⋯ & {R}_{f} ( {k}_{P} - {k}_{1} ) {R}_{t} ( {b}_{P} - {b}_{1} ) \\ {R}_{f} ( {k}_{1} - {k}_{2} ) {R}_{t} ( {b}_{1} - {b}_{2} ) & {R}_{f} ( 0 ) {R}_{t} ( 0 ) & ⋯ & {R}_{f} ( {k}_{P} - {k}_{2} ) {R}_{t} ( {b}_{P} - {b}_{2} ) \\ ⋮ & & ⋰ & ⋮ \\ {R}_{f} ( {k}_{1} - {k}_{P} ) {R}_{t} ( {b}_{1} - {b}_{P} ) & {R}_{f} ( {k}_{2} - {k}_{P} ) {R}_{t} ( {b}_{2} - {b}_{P} ) & ⋯ & {R}_{f} ( 0 ) {R}_{t} ( 0 )\end{matrix} ] & ( 26 ) \\ g ( k , b ) = [ \begin{matrix}{R}_{f} ( k - {k}_{1} ) {R}_{t} ( b - {b}_{1} ) \\ ⋮ \\ {R}_{f} ( k - {k}_{P} ) {R}_{t} ( b - {b}_{P} )\end{matrix} ] & ( 27 )\end{matrix}$$

where R_{f}(k) is the expected frequency correlation and R_{f}(b) is the expected time correlation. Using the correlation for a square delay profile (15), these values along with the expected TxAA gain, G, are given as:

$$\begin{matrix}{R}_{t} ( b ) = \{ \begin{matrix}1 if b = 0 \\ \frac{sin ( 2 π {f}_{d} {bT}_{b} )}{2 π {f}_{d} {bT}_{b}} if b \neq 0\end{matrix} & ( 28 ) \\ C = 1 + \frac{2}{M} {\sum }_{q = 1}^{M - 1} ( M - q ) {J}_{0}^{2} ( 2 π q {Δ}_{a} ) & ( 29 ) \\ D = {MJ}_{0}^{2} ( 2 π {f}_{d} {dT}_{b} ) & ( 30 ) \\ {r}_{mid} = D + C - \frac{C}{{τ}_{max} / {Δ}_{t}} & ( 31 ) \\ G = {r}_{mid} - D / M & ( 32 ) \\ {R}_{f} ( k ) = \{ \begin{matrix}1 if k = 0 \\ \frac{1}{{r}_{mid}} \{ D - \frac{C}{{τ}_{max} / {Δ}_{t}} + {C ( \frac{sin ( π k {τ}_{max} {Δ}_{f} )}{π k {τ}_{max} {Δ}_{f}} )}^{2} \} if k \neq 0\end{matrix} & ( 33 )\end{matrix}$$

where f_{d} is the current Doppler frequency in Hz (or estimated from a speed value), T_{b} is the OFDM baud (symbol) duration in seconds, M is the number of transmit antennas at the base, Δₐ is the inter-element spacing at the base (assuming a uniform linear array) in wavelengths, J₀(n) is the zero-order Bessel function of the first kind, d is the weights application delay in number of OFDM bauds (d can be chosen as the delay from sounding to the middle of the RE), τₘₐₓ is either the current maximum delay spread in seconds being experienced at the mobile or is the expected maximum delay spread in seconds, Δₜ is the sampling rate and Δ_{f} is the subcarrier spacing in Hz. Note that the mobile unit must know:
1. The number of transmit antennas at the base.
2. The antenna spacing at the base (the derivation assumes a uniform linear array at the base but can be easily extended to other array geometries).
3. The current maximum Doppler frequency the mobile is experiencing (a velocity estimate is typically sufficient).
4. The current noise power.
   In addition, if the mobile can estimate τₘₐₓ, then the channel estimation can be further improved by better matching the assumed delay profile to the true delay profile.

Referring to FIG. 4, a system 10 for estimating an aggregate channel can include a base station 12, for example, having a transmit antenna array employing frequency selective closed-loop beamforming, a receiver unit or other mobile device 15 having a receiver 14 in communication with the transmit antenna array, and a processor 16 coupled to the receiver 14. As will be discussed in further detail below with respect to the method, the receiver unit 15 can be programmed to receive a beamformed signal from the transmit antenna array and compute a set of characteristics for an aggregate channel from the beamformed signal using a plurality of frequency selective weights and a frequency-selective multi-antenna channel response to create an aggregate channel estimate. The receiver can be further programmed to demodulate and decode a received beamformed signal using the aggregate channel estimate.

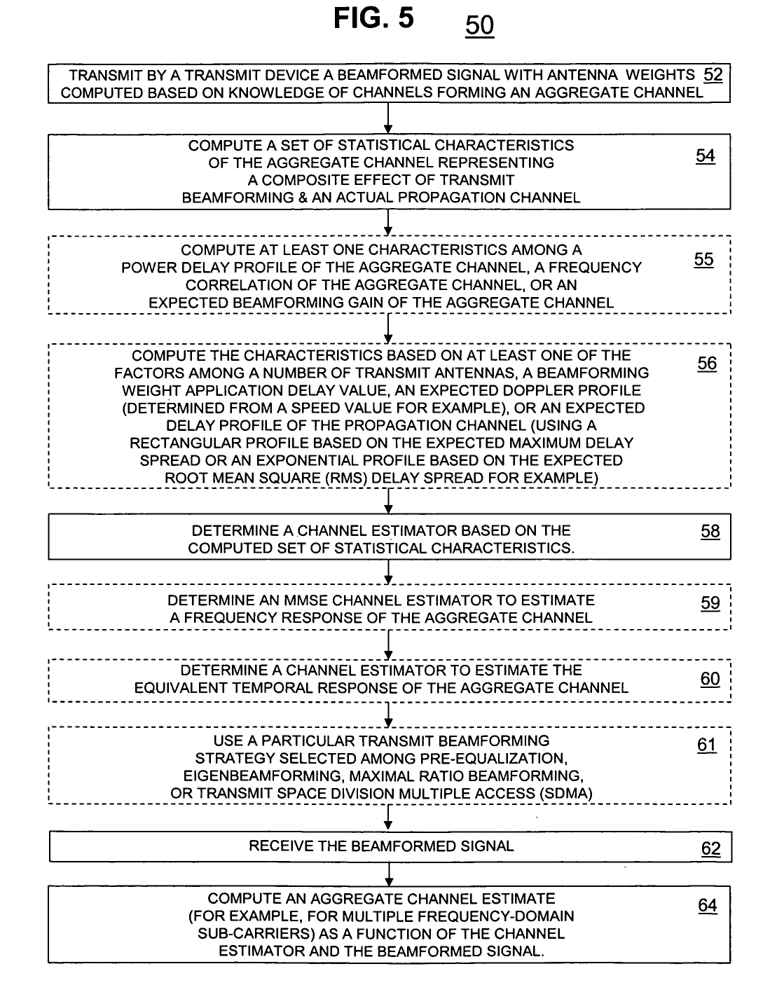

Referring to FIG. 5, a method 50 of operating a wireless communication system between a transmit device employing an array of transmit antennas and a receiver can include the step 52 of transmitting by the transmit device a beamformed signal with antenna weights computed based on knowledge of a plurality of channels forming an aggregate channel, the receiver computing a set of statistical characteristics of the aggregate channel that represents a composite effect of transmit beamforming and an actual propagation channel at step 54, and the receiver determining at step 58 a channel estimator based on the computed set of statistical characteristics. The method 50 further includes the step 62 of the receiver receiving the beamformed signal and computing at step 64 an aggregate channel estimate (for example, for multiple frequency-domain sub-carriers) as a function of the channel estimator and the beamformed signal.

Computing the set of statistical characteristics can optionally include computing at least one characteristics among a power delay profile of the aggregate channel, a frequency correlation of the aggregate channel, or an expected beamforming gain of the aggregate channel at step 55. The step of computing the set of statistical characteristics can further include at step 56 of computing the characteristics based on at least one of the factors among a number of transmit antennas, a beamforming weight application delay value, an expected Doppler profile, or an expected delay profile of the propagation channel. The factor of the expected delay profile can include for example a rectangular profile based on the expected maximum delay spread or an exponential profile based on the expected root mean square (RMS) delay spread. The expected Doppler profile can include a Doppler profile determined from a speed value. Determining the channel estimator can involve determining an MMSE channel estimator to estimate a frequency response of the aggregate channel at step 59 or alternatively determining a channel estimator to estimate the equivalent temporal response of the aggregate channel at step 60. Determining the channel estimator can be performed at step 61 using a particular transmit beamforming strategy selected among pre-equalization, eigenbeamforming, maximal ratio beamforming, or transmit space division multiple access (SDMA).

As suggested above, embodiments for channel estimators do not necessarily need to follow an MMSE derivation exactly, but can be derived from using just a subset of the computed characteristics or a simplified approximation of the computed characteristics. For example, the channel estimator can be derived from a certain fixed power delay profile that does not involve Doppler profile or the expected beamforming gain. A more intelligent option can have an estimator that assumes some fixed shape of power delay profile (e.g., rectangular or triangle) with a spike in the middle to approximate the true power delay profile, where the spike represents a K-factor and can be approximated based on a mean beamforming gain (some function of the number of antennas, weight application delay and Doppler profile. But these factors may not be explicitly involved as in the mathematical derivation).

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of operating a wireless communication system between a transmit device employing an array of transmit antennas and a receiver where the transmit device transmits a beamformed signal with antenna weights computed based on knowledge of a plurality of channels forming an aggregate channel, the method comprising the receiver steps of:
computing a set of statistical characteristics of the aggregate channel that represents a composite effect of transmit beamforming and an actual propagation channel;
determining a channel estimator based on the computed set of statistical characteristics;
receiving the beamformed signal; and
computing an aggregate channel estimate as a function of the channel estimator and the beamformed signal.

2. The method of claim 1, wherein the step of computing the set of statistical characteristics comprises the step of computing at least one of the following characteristics:
a power delay profile of the aggregate channel;
a frequency correlation of the aggregate channel; and
an expected beamforming gain of the aggregate channel.

3. The method of claim 1, wherein the step of computing the set of statistical characteristics further comprises the step of computing the characteristics based on at least one of the following factors:
a number of transmit antennas;
a beamforming weight application delay value;
an expected Doppler profile; and
an expected delay profile of the propagation channel.

4. The method of claim 3, wherein the expected delay profile includes a rectangular profile based on the expected maximum delay spread.

5. The method of claim 3, wherein the expected delay profile includes an exponential profile based on the expected root mean square (RMS) delay spread.

6. The method of claim 3, wherein the expected Doppler profile includes a Doppler profile determined from a speed value.

7. The method of claim 1, wherein the step of determining the channel estimator involves determining an MMSE channel estimator to estimate a frequency response of the aggregate channel.

8. The method of claim 1, wherein the step of determining the channel estimator involves determining a channel estimator to estimate the equivalent temporal response of the aggregate channel.

9. The method of claim 1, wherein the step of determining the channel estimator is performed using a particular transmit beamforming strategy selected among pre-equalization, eigenbeamforming, maximal ratio beamforming, or transmit space division multiple access (SDMA).

10. The method of claim 1 wherein the step of computing the aggregate channel estimate involves computing an aggregate channel estimate for multiple frequency-domain subcarriers.

11. A receiver unit in communication with a transmit device having an array of transmit antennas, comprising:
a receiver; and
a processor coupled to the receiver, wherein the receiver unit is programmed to:
receive a beamformed signal;
compute a set of characteristics of an aggregate channel that represents a composite effect of transmit beamforming and an actual propagation channel;
determine a channel estimator based on the computed set of statistical characteristics; and
compute an aggregate channel estimate as a function of the channel estimator and the beamformed signal.

12. The receiver unit of claim 11, wherein the receiver unit is further programmed to demodulate and decode a received beamformed signal using the aggregate channel estimate.

13. The receiver unit of claim 11, wherein the processor is further programmed to provide the array of transmit antennas with a channel estimate at a first time value and transmit by the array of transmit antennas a multi-antenna signal at a second time value based on the channel estimate at a first time interval.

14. The receiver unit of claim 13, wherein the receiver unit provides the channel estimate to the array of transmit antennas by transmitting a sounding waveform or a feedback message from the receiver unit to the transmit device.

15. The receiver unit of claim 11, wherein the aggregate channel estimate is computed based on information selected among a time difference between the second time value and the first time value or a frequency correlation function computed based on an aggregate channel delay spread profile.

16. The receiver unit of claim 11, wherein the processor models the aggregate channel using a particular transmit beamforming strategy selected among maximal ratio beamforming or transmit space division multiple access (SDMA) in a minimum mean-square error (MMSE)-based channel estimator.

17. The receiver unit of claim 11, wherein the receiver unit models the aggregate channel by applying transmit weight vectors to each subcarrier in the aggregate channel.

18. The receiver unit of claim 17, wherein the receiver unit models the aggregate channel by forming a product of transmit weight vectors and channel vectors at each subcarrier in the frequency domain or by the circular convolution of a multipath channel with an IFFT across frequency of the transmit weight vectors.

19. A system including a transmit antenna array employing frequency selective closed-loop beamforming for estimating an aggregate channel, comprising:
a receiver unit having a receiver in communication with the transmit antenna array; and
a processor coupled to the receiver, wherein the receiver unit is programmed to:
receive a beamformed signal from the transmit antenna array;
compute a set of characteristics of an aggregate channel that represents a composite effect of transmit beamforming and an actual propagation channel;
determine a channel estimator based on the computed set of statistical characteristics; and
compute an aggregate channel estimate as a function of the channel estimator and the beamformed signal.

20. The system of claim 19, wherein the receiver unit is further programmed to demodulate and decode a received beamformed signal using the aggregate channel estimate.
